(19) United States
(12) Patent Application Publication
(10) Pub. No.: US 2015/0240989 A1
(43) Pub. Date: Aug. 27, 2015

(54) DECORATIVE APPARATUS FOR DISPLAYING AN ITEM

(71) Applicant: Michael Peretti, Las Vegas, NV (US)

(72) Inventor: Michael Peretti, Las Vegas, NV (US)

(21) Appl. No.: 14/710,076

(22) Filed: May 12, 2015

Related U.S. Application Data
(63) Continuation-in-part of application No. 13/587,336, filed on Aug. 16, 2012.
(60) Provisional application No. 61/628,750, filed on Nov. 7, 2011.

(51) Int. Cl. F16M 13/02

(52) U.S. Cl. CPC F16M 13/02

(57) ABSTRACT

An apparatus for displaying a piece of memorabilia on a support surface includes at least one holder for holding the piece of memorabilia. The holder includes a decorative end that is affiliated with said piece of memorabilia. In some embodiments the piece of memorabilia is sports related.

### CROSS-REFERENCE TO RELATED APPLICATIONS

This application is a continuation-in-part of U.S. patent application Ser. No. 13/587,336 filed on Aug. 16, 2012, entitled “Apparatus for Displaying a Sports Item and Method of Use”. The '336 application claims priority benefits from U.S. provisional patent application No. 61/628,750 filed on Nov. 7, 2011. The '750 and '336 applications are hereby incorporated by reference in their entirety.

### FIELD OF THE INVENTION

The present invention pertains generally to an apparatus for displaying various pieces of memorabilia. In some embodiments the apparatus helps display sports memorabilia.

### BACKGROUND OF THE INVENTION

Individuals often display various memorabilia items in a location which can be readily viewed. For example, player jerseys, football helmets, baseball bats, various sports balls, and the like are often displayed to enhance the decor of a sports bar or an individual's home. These memorabilia items can be items which were actually used by the individual and/or can be collector's items.

Similarly entertainment memorabilia including, but not limited to, guitars, records and movie props can also be displayed.

### SUMMARY OF THE INVENTION

An apparatus for displaying a piece of memorabilia, such as a piece of sports memorabilia, allows pieces of memorabilia to be prominently displayed. The apparatus includes one or more holders or hangers which are used to mount pieces of memorabilia on a support surface such as a wall. When the piece of memorabilia is a piece of sports memorabilia, the decorative end of the holder can comprise another sports item, thereby providing a decorative display which has a complementing sport theme. In one embodiment the decorative end is an imitation sports item (facsimile or replica). In another embodiment the decorative end is a genuine sports item which is used in the play of the sport.

In some embodiments, the apparatus for displaying a piece of sports memorabilia which is used in a particular sport includes at least one holder for holding the piece of sports memorabilia. The decorative end of the holder can be a different sports item from the same sport as the piece of sports memorabilia. The holder can also include a connector for connecting the holder to the support surface.

In some embodiments, the decorative end of the holder is one of an imitation sports item or a genuine sports item. In other or the same embodiments, the decorative end includes a recess for accepting the piece of sports memorabilia. In accordance with another embodiment, in the play of the particular sport, the decorative end is smaller than the piece of sports memorabilia.

In accordance with another embodiment, in the play of the particular sport, the decorative end is struck by the piece of sports memorabilia and/or caught by the piece of sports memorabilia.

In accordance with another embodiment a plurality of holders are utilized. The plurality of holders can either be identical or different in size and/or shape.

In accordance with another embodiment, the support surface is a wall. The holders are connected to the wall so that the piece of sports memorabilia rests upon the holders. In some embodiments the piece of sports memorabilia can be removed from the wall without disconnecting the holders from the wall.

In terms of use, a method for displaying a piece of sports memorabilia includes: providing a support surface (such as a wall); providing a piece of sports memorabilia used in a particular sport; providing at least one holder for a piece of sports memorabilia, the decorative end of the holder being a different sports item from the same sport as the piece of sports memorabilia, and the holder including a connector for connecting the holder to the support surface; connecting the holder to the support surface; and, using the holder to mount the piece of sports memorabilia on the support surface.

In some embodiments the method includes resting the piece of sports memorabilia on the holder. In these embodiments the piece of sports memorabilia can be removed from the holder without removing the holder from the support surface.

In some embodiments the holder includes a recess for accepting the piece of sports memorabilia. In the same or other embodiments, the decorative end of the holder is a sports item (either genuine or imitation) that is traditionally smaller than the piece of sports memorabilia.

Other embodiments, in addition to the embodiments enumerated above, will become apparent from the following detailed description, taken in conjunction with the accompanying drawings, which illustrate, by way of example, the principles of the apparatus and method of use.

### BRIEF DESCRIPTION OF THE DRAWINGS

FIG. 1 is a side elevation view of a display for a piece of sports memorabilia showing the piece of sports memorabilia connected to a support surface.

FIG. 2 is a front elevation view of the display for the piece of sports memorabilia.

FIG. 3 is an enlarged side elevation view of a holder.

FIG. 4 is an enlarged perspective view of a second embodiment holder.

FIG. 5 is a front elevation view of another display for a piece of sports memorabilia.

FIG. 6 is a front elevation view of another display for a piece of sports memorabilia.

FIG. 7 is a front elevation view of another display for a piece of sports memorabilia.

FIG. 8 is a front elevation view of another display for a piece of sports memorabilia.

FIG. 9 is a front elevation view of another display for a piece of sports memorabilia.

FIG. 10 is a front elevation view of another display for a piece of sports memorabilia.

FIG. 11 is a front elevation view of another display for a piece of sports memorabilia.

FIG. 12 is an exploded side view of a holder utilizing a drywall anchor.

FIG. 13 is an exploded side view of another holder utilizing a drywall anchor.

### DETAILED DESCRIPTION OF PREFERRED EMBODIMENT(S)

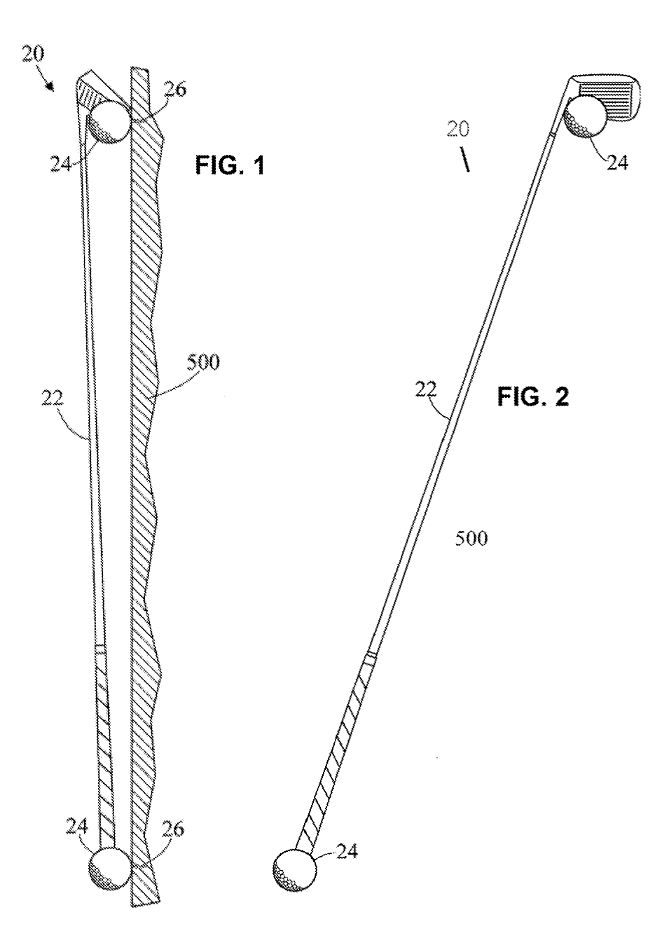

FIGS. 1 and 2 are side and front elevation views of display 20 for piece of sports memorabilia 22 with piece of sports memorabilia 22 connected to support surface 500. In the shown embodiments support surface 500 is a wall however other vertical support surfaces or even horizontal support surfaces could be utilized. Display 20 includes piece of sports memorabilia 22 which is/was used in a particular sport.

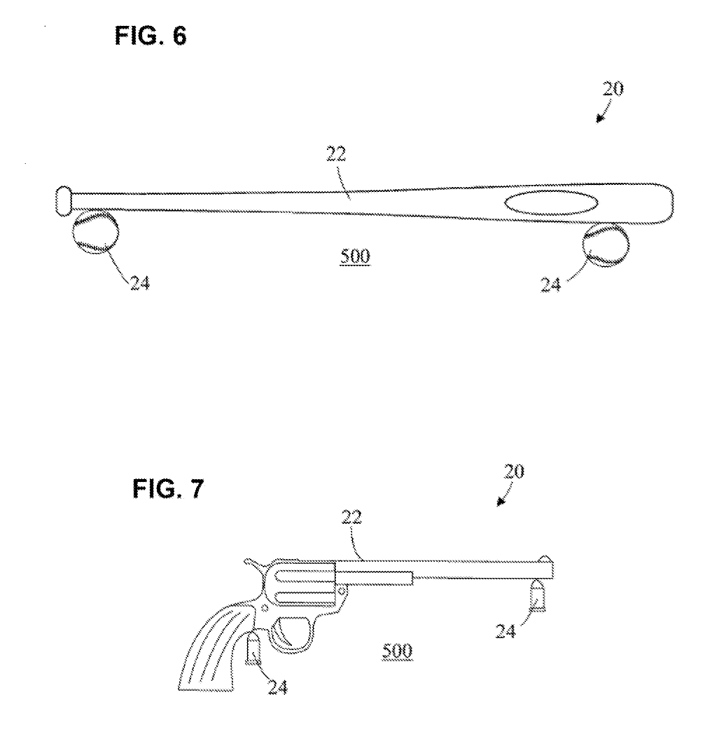

In one embodiment, piece of sports memorabilia 22 is a genuine sports item which was actually used in the play of the particular sport either by the display creator or by another person. For example, in FIG. 1 piece of sports memorabilia 22 could be the golf club which the display creator used to score a “hole-in-one”, or referring to FIG. 6, piece of sports memorabilia 22 could be a collectible bat which was used by a major leaguer to hit a World Series-winning home run. In many cases, the creator of display 20 provides piece of sports memorabilia 22.

In some embodiments, piece of sports memorabilia 22 is a genuine sports item used in the play of the particular sport, regardless of whether it has actually been used is the sport. Display 20 further includes at least one holder 24 for holding piece of sports memorabilia 22. In the embodiment shown in FIG. 1, a plurality of holders 24 (two golf balls) are used.

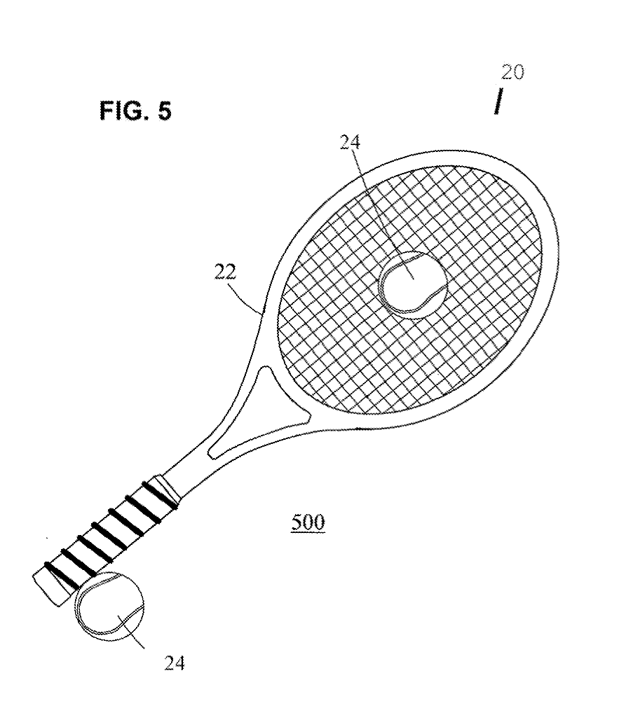

In some embodiments holder 24 includes a decorative end made of a different sports item from the same sport as piece of sports memorabilia 22. That is, both piece of sports memorabilia 22 and holder 24 are used in the same sport but are different items (such as a golf club and a golf ball, a baseball bat and a baseball, a tennis racquet and a tennis ball, etc.). In FIG. 1, piece of sports memorabilia 22 is a golf club, and the decorative ends of holders 24 are golf balls. Similarly, in FIG. 5, piece of sports memorabilia 22 is a tennis racquet, and the decorative ends of holders 24 are tennis balls.

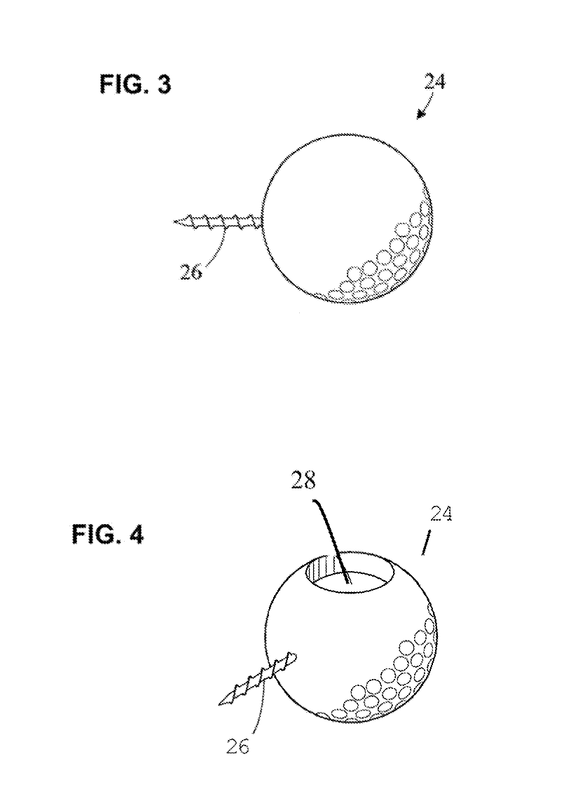

As shown in FIGS. 3, 12 and 13, holder 24 includes connector 26 for attaching holder 24 to support surface 500. In FIGS. 1-11 holder 24 is a hanger for hanging piece of sports memorabilia 22 on vertical support surface 500 such as a wall, and connector 26 is a screw which attaches holder 24 to support surface 500. Connector 26 can include various structures for connecting holder 24 to support surface 24. For example, other than a screw, connector 26 could be a bolt, a pin, a clamp, an adhesive, a hook and loop fastener, or the like.

In some embodiments the decorative end of holder 24 is either an imitation sports item. As defined herein, an imitation sports item is a sports item which is shaped and dimensioned to look like a genuine sports item, however which is not intended to be used in the play of the sport. For example, in FIG. 1 the decorative end of holder 24 could be as hollow polymer sphere which looks like a golf ball, but could not be used to play a game of golf. Similarly in FIG. 7, the decorative end of holder 24 could be a polymer representation of a bullet (an imitation) rather than an actual bullet.

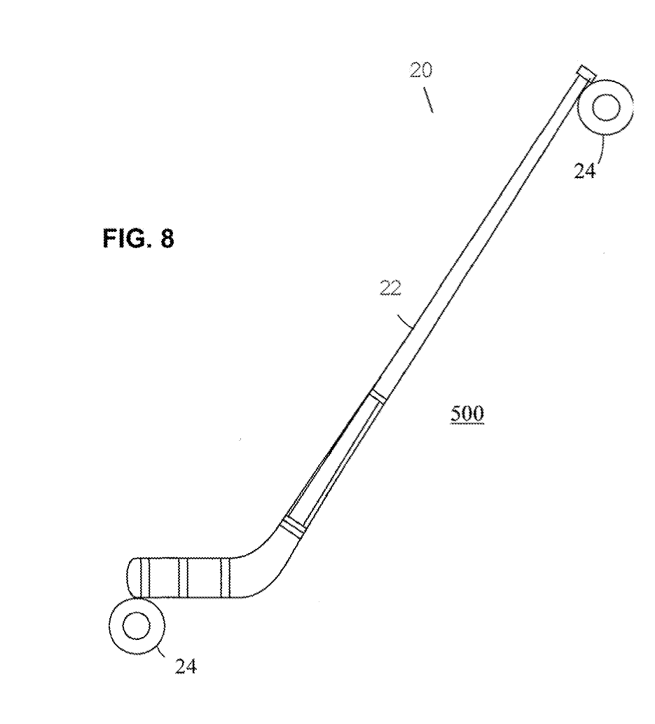

Conversely, the decorative end of holder 24 could be a genuine sports item which was or could be used to play the associated sport. For example in FIG. 8, the decorative ends of holders 24 could be genuine hockey pucks which hold piece of sports memorabilia 22 which is a hockey stick. In some embodiments, the decorative end of holder 24 is made of a smaller sport item than piece of sports memorabilia 22. As used herein the term “smaller” means smaller in volume. For example in FIG. 1 the decorative end of holder 24 (a golf ball) is smaller than piece of sports memorabilia 22 (a golf club). Similarly in FIG. 5, the decorative end of holder 24 (a tennis ball) is smaller than piece of sports memorabilia 22 (tennis racquet).

In some embodiments, in the play of the particular sport, the decorative end of holder 24 is struck by piece of sports memorabilia 22. For example in FIG. 1 holder 24 (a golf ball) is struck by piece of sports memorabilia 22 (a golf club) during a game of golf. Similarly in FIG. 6, the decorative end of holder 24 (a baseball) is struck by piece of sports memorabilia 22 (a bat) during a game of baseball.

Referring to FIGS. 1 and 2, support surface 500 is a wall. Holders 24 are attached to the wall so that piece of sports memorabilia 22 rests upon holders 24, and can be removed from display 20 without disconnecting holders 24 from the wall. For example, piece of sports memorabilia 22 (golf club) rests upon one holder 24 (golf ball) near its head, and rests upon another holder 24 (golf ball) at the end of the grip. There is no fixed physical connection between piece of sports memorabilia 22 and holders 24. Instead piece of sports memorabilia 22 (golf club) simply rests upon and is kept in place by two holders 24 (golf balls). As such, a user can easily remove piece of sports memorabilia 22 (golf club) from the holders 24 without removing the holders (golf balls) from support surface 500 (the wall). Therefore, the display creator could elect to display piece of sports memorabilia 22 as shown in FIGS. 1 and 2, and also periodically remove piece of sports memorabilia 22 to play the particular game (e.g. play a round of golf).

FIG. 3 is an enlarged side elevation view of holder 24. In the shown embodiment the decorative end of holder 24 is a golf ball. Holder 24 includes connector 26 which is used to attach holder 24 to support surface 500 (refer to FIGS. 1 and 2). In the shown embodiment connector 26 is a screw which can be screwed into support surface 500 (such as a wall). However connector 26 could be another connector that attaches holder 24 to support surface 500 (eg. a bolt, nail, clip, pin, magnetic connector, adhesive, hook-and-loop fasteners, and the like).

FIG. 4 is an enlarged perspective view of another holder 24. In this embodiment the decorative end of holder 24 includes recess 28 for accepting piece of sports memorabilia 22. In FIGS. 1 and 2, recess 28 is a columnar recess which accepts the end of the shaft of piece of sports memorabilia 22 (golf club).

FIG. 5 is a front elevation view of another display 20 for piece of sports memorabilia 22 mounted on support surface 500. In this embodiment piece of sports memorabilia 22 is a tennis racquet, and the decorative ends of holders 24 are tennis balls. In this embodiment one holder 24 (tennis ball) is placed through the strings of piece of sports memorabilia 22 (tennis racquet), and as such piece of sports memorabilia 22 is connected to holder 24, and could not be removed from support surface 500 without first removing holder 24. This is different from the embodiments illustrated in FIGS. 1-2, 6-8, and 10-11 in which piece of sports memorabilia 22 simply rests upon holders 24 and can be removed from the display without disconnecting holders 24 from surface 500.

FIG. 6 is a front elevation view of another display 20 for piece of sports memorabilia 22 mounted on support surface 500. In this embodiment piece of sports memorabilia 22 is a baseball bat and the decorative ends of holders 24 are baseballs.

FIG. 7 is a front elevation view of another display 20 for sports item 22 mounted on 20 support surface 500. In this embodiment piece of sports memorabilia 22 is a pistol, and the decorative ends of holders 24 are bullets.

FIG. 8 is a front elevation view of another display 20 for piece of sports memorabilia 22 mounted on support surface 500. In this embodiment piece of sports memorabilia 22 is a hockey stick, and the decorative ends of holders 24 are hockey pucks.

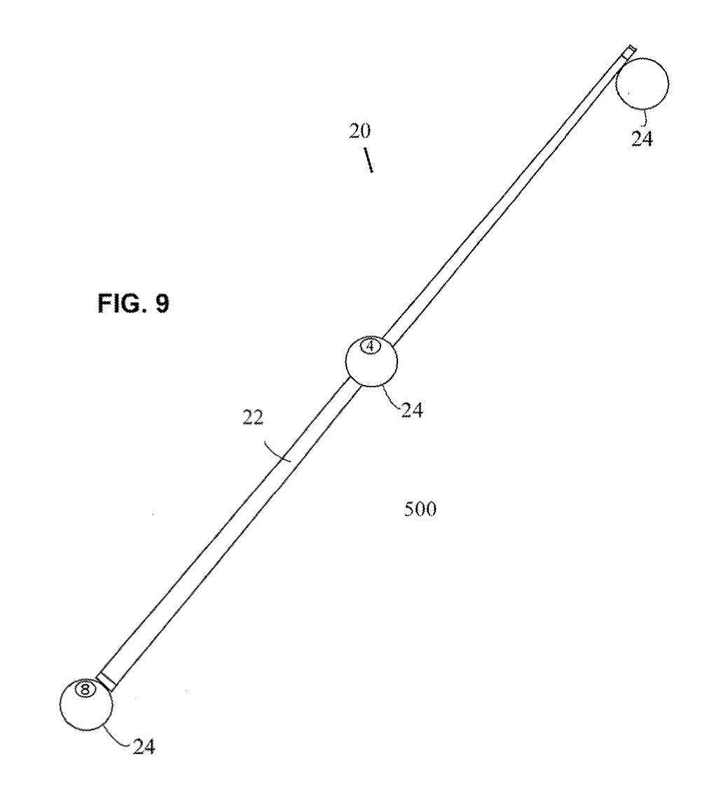

FIG. 9 is a front elevation view of another display 20 for piece of sports memorabilia 22 mounted on support surface 500. In this embodiment piece of sports memorabilia 22 is a pool cue, and the decorative ends of holders 24 are pool balls. It is noted that in this embodiment, the decorative end of holder 24 (one of the pool balls) has a through hole which accepts the piece of sports memorabilia 22 (pool cue).

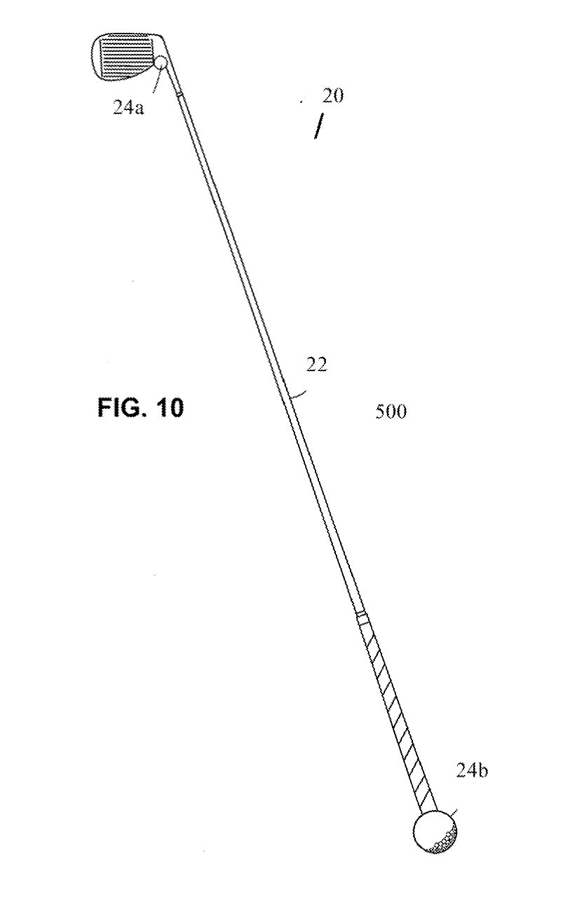

FIG. 10 is a front elevation view of another display 20 for piece of sports memorabilia 22 mounted on support surface 500. As in FIGS. 1 and 2, piece of sports memorabilia 22 is a golf club. However, rather than the decorative ends of holders 24 being two identical golf balls as in FIGS. 1 and 2, in this embodiment two different holders 24a and 24b are used. The decorative end of holder 24a is a golf tee, and the decorative end of bottom holder 24b is a golf ball, both of which are from the same sport of golf, and both of which are different from each other and from piece of sports memorabilia 22.

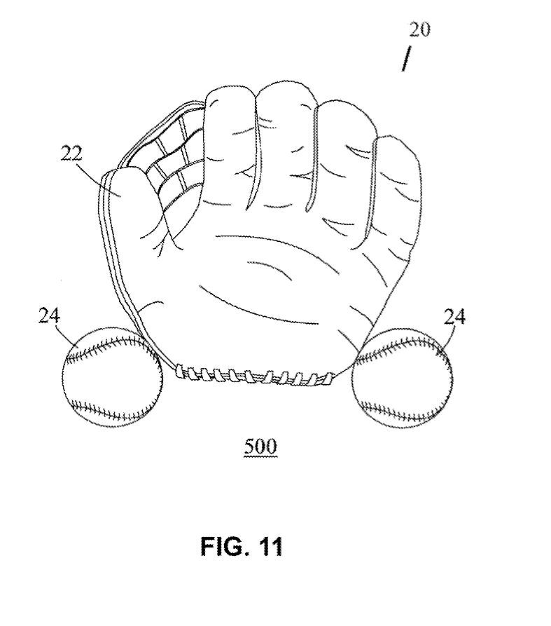

FIG. 11 is a front elevation view of another display 20 for piece of sports memorabilia 22 mounted on support surface 500. In this embodiment piece of sports memorabilia 22 is a baseball mitt, and the decorative ends of holders 24 are baseballs. As such, in the play of the sport (baseball) holders 24 (baseballs) are caught by piece of sports memorabilia 22 (a baseball mitt).

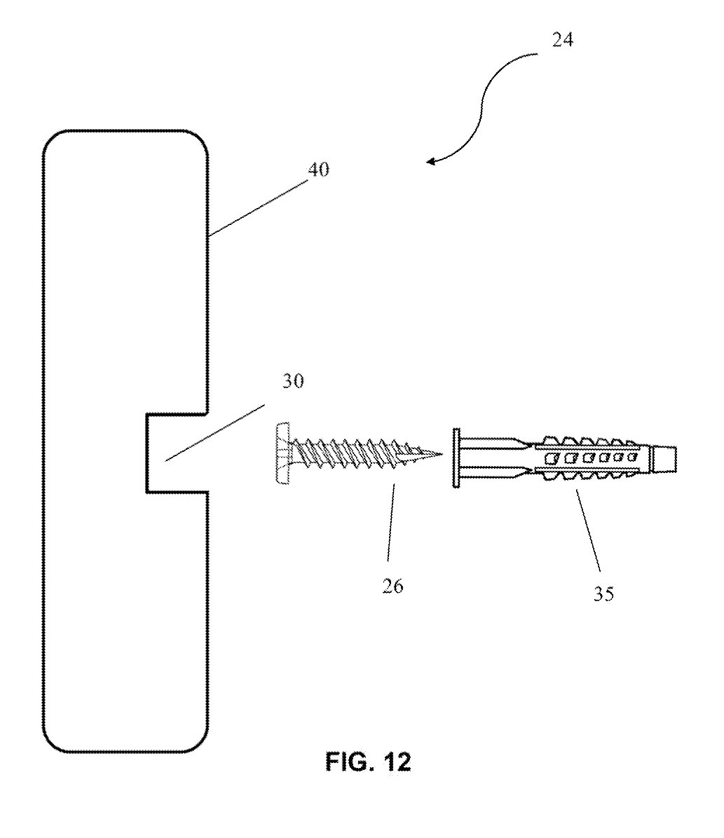

FIG. 12 is an illustration of holder 24. Holder 24 includes decorative end 40 (in FIG. 12 a hockey puck) and absence 30 in which connector 26 is attached to decorative end 40. In some embodiments connector 26 is attached to decorative end 40 using an epoxy although other materials such as cement and glues can be used as well. In FIG. 12, connector 26 is a screw which can be utilized with anchor 35 to attach holder 24 to a support surface such as a wall.

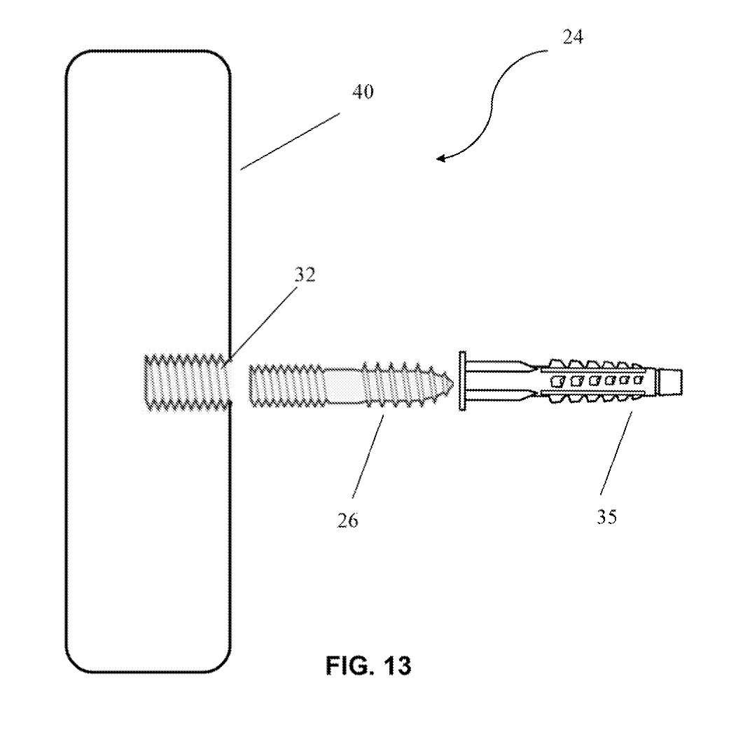

FIG. 13 is an illustration of holder 24. Holder 24 includes decorative end 40 (in FIG. 13 a hockey puck) and threaded absence 32. In some embodiments threaded absence 32 is a nut that has been interested into decorative end 40. Connector 26 is configured to utilize threaded absence 32 to attach to decorative end 40. In some embodiments connector 26 is a hanger bolt. In FIG. 13 connector 26 is a hanger bolt which can be utilized with anchor 35 to attach holder 24 to a support surface such as a wall.

Utilizing threaded absence 32 with a hanger bolt allows for quick assembly of holder 24 and cheaper shipping as holder 24 can be easily assembled without the use of epoxies, glues, and the like.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A holder configured to display a piece of memorabilia comprising:
(a) a connector for connecting said holder to a support surface; and
(b) a decorative end, wherein said decorative end is in the three-dimensional shape and size of a piece of sports equipment.

2. The holder of claim 1 wherein said connector is attached to said decorative end via a threaded absence.

3. The holder according to claim 1 wherein said decorative end is a regulation conforming piece of sports equipment.

4. The holder according to claim 3 wherein said decorative end was used during a professionally sanctioned sporting event.

5. The holder according to claim 1 wherein said piece of sports equipment is made of a plastic.

6. The holder according to claim 1 wherein said holder has a recess for accepting said piece of memorabilia.

7. The holder according to claim 2 wherein said connector is a screw.

8. The holder according to claim 1 wherein said connector is an adhesive material.

9. The holder according to claim 4 wherein said piece of sports equipment is a baseball.

10. The holder according to claim 4 wherein said piece of sports equipment is a hockey puck.

11. The holder according to claim 4 wherein said piece of sports equipment is a golf ball.

12. The holder according to claim 4 wherein said piece of sports equipment is a tennis ball.

13. The holder according to claim 4 wherein said piece of sports equipment is a pool ball.

14. The holder according to claim 3 wherein said piece of sports equipment is a bullet.

15. The holder according to claim 4 wherein said piece of memorabilia is a hockey stick.

16. A method for displaying a sports item the steps comprising:
(a) placing a piece of memorabilia against a display surface using a first holder, wherein said first holder comprises:
(1) a connector for connecting said holder to said display surface; and
(2) a first regulation conforming piece of sports equipment.

17. The method of claim 16 wherein said piece of memorabilia rests on said first holder.

18. The method of claim 17 wherein said first holder has a recess configured to receive said sports item.

19. The method of claim 17 wherein a second holder is used in conjunction with said first holder.

20. The method of claim 19 wherein said second holder comprises a second regulation conforming piece of sports equipment wherein said second regulation conforming piece of equipment is different than said first regulation conforming piece of sports equipment.
